(19) United States
(12) Patent Application Publication
(10) Pub. No.: US 2020/0199013 A1
(43) Pub. Date: Jun. 25, 2020

(54) THIN GLASS WITH IMPROVED BENDABILITY AND CHEMICAL TOUGHENABILITY

(71) Applicant: SCHOTT Glass Technologies (Suzhou) Co. Ltd., Suzhou (CN)

(72) Inventors: Junming XUE, Shanghai (CN); Feng HE, Suzhou (CN); José ZIMMER, Eppstein (DE); Oliver HOCHREIN, Mainz (DE); Ning DA, Suzhou (CN)

(73) Assignee: SCHOTT Glass Technologies (Suzhou) Co. Ltd., Suzhou (CN)

(21) Appl. No.: 16/808,538

(22) Filed: Mar. 4, 2020

Related U.S. Application Data
(63) Continuation of application No. PCT/CN2017/100429, filed on Sep. 4, 2017.

(51) Int. Cl. C03C 3/118; C03C 3/112; C03C 3/095; C03C 4/00; C03B 17/06; C03B 25/12; C03C 21/00

(52) U.S. Cl. CPC C03C 3/118; C03C 3/112; C03C 3/095; C03C 2204/08; C03B 17/06; C03B 25/12; C03C 21/002; C03C 4/00

(57) ABSTRACT

A chemically toughenable or toughened glass is provided. The glass has, before chemical toughening, a thickness of at most 500 μm. The glass, after chemical toughening, has a BACT (bendability and chemical toughenability) calculated as BACT=(CS*DoL)/(t*E) which is greater than 0.00050 and/or a NS (normalized stiffness) calculated as NS=CS/E which is greater than 0.0085, where CS is a compressive stress in MPa measured at one side of the glass after chemical toughening, DoL is a total depth of all ion-exchanged layers in μm on one side of the glass after chemical toughening, t is a thickness of the glass in μm after chemical toughening, and E is a E-modulus in MPa after chemical toughening.

### CROSS REFERENCE TO RELATED APPLICATIONS

This application is a continuation of International Application PCT/CN2017/1004429 filed Sep. 4, 2017, the contents of which are incorporated by reference herein.

### BACKGROUND

### 1. Field of the Invention

The present invention relates to a thin chemically toughenable or toughened aluminosilicate glass with improved bendability, chemical toughening property and radiation stability. The present invention also relates to a method for producing the glass of the invention as well as to uses of the glass. The glass is preferably used in applications in the field of industrial and consumer Displays, OLEDs, photovoltaic cover and organic complementary metal oxide semiconductor (CMOS) and other electronic devices.

### 2. Description of Related Art

An active-matrix organic light-emitting diode (AMOLED) is an enabler for a flexible display, which requires flexible material used as display cover and/or as substrate. For such applications, the glasses usually will be chemically toughened to achieve a high mechanical strength, as determined by different test methods such as impact resistance, 3-point bending (3PB), ball drop, anti-scratch and others. Thin Aluminosilicate (AS) glass is one of the ideal material for such flexible applications.

In present times, the continuous demand for new functionality of product and wider area of applications call for glasses even thinner and lighter with high strength and flexibility, also called bendability. The fields in which thin glass typically applied are protective cover of fine electronics. At the present time, the increasing demands for new functionalities of products and exploiting new and broad applications call for thinner and lighter glasses with new properties such as flexibility. Due to the flexibility of thin glass such glasses have been searched and developed as cover glasses and displays for devices such as for example smartphones, tablets, watches and other wearables. Such a glass can also be used as a cover glass of a finger print sensor module and as camera lens cover.

However, if glass sheet gets thinner than 0.5 mm, handling will get more and more difficult mainly due to defects such as cracks and chippings at the glass edges, which lead to breakage. In addition, the overall mechanical strength i.e. reflected in bending or impact strength will be significantly reduced. Usually the edge of thicker glass could be CNC (computer numerical control) grinded to remove the defects, but, the mechanical grinding is hardly applied for ultrathin glass with thickness less than 0.3 mm. Etching on the edge could be one solution for ultrathin glass to remove defects, but the flexibility of thin glass sheet is still limited by the low bending strength of glass itself. As a result, strengthening of the glasses is extremely important for thin glasses. However, for thin glass strengthening is always accompanied by the risk of self breakage due to high central tensile stress of glass.

Typically, ≤0.5 mm thick flat thin glasses can be produced by direct hot-forming methods such as down draw, overflow fusion or special float procedures. Redraw methods are also possible. Compared with post-treated thin glass by chemical or physical method (e.g. produced via grinding and polishing and/or etching), the direct hot-formed thin glass has much better surface uniformity and surface roughness because the surfaces are cooled down from high temperature melting state to room temperature. Down-drawn method could be used to produce thin aluminosilicate glasses with high surface quality wherein thickness can also be precisely controlled ranging from 5 μm and 500 μm.

In the past much effort has been spent targeting on developing new materials suitable for chemical toughening. For instance, US2012156464 disclosed a chemical toughenable glass with good surface quality.

However, to fully satisfy the requirement from the above mentioned applications, there are still several problems needing to be solved for AS glass in order to get thin glasses with improved properties:

Bendability: Glass as a fragile material has certain bending limitation, which limits the design of the flexible display. Theoretically, radius of curvature is proportional to E-modulus (also called Young's modulus) and sample thickness at the certain stress. Therefore, lowering E-modulus from the material side and thinning the sample thickness can benefit the curvature.

Chemical toughenability: For thicker glasses, e.g. cover glass, having for instance a thickness of 0.55 mm, it is appropriate to have a CS (compressive stress) as 850 MPa and a DoL (depth of layer) of 30 μm. However, for flexible display, when thin glass with lower thickness—like for example 100 μm—is used, such high DoL is disadvantageous. Such toughened glasses can be easily broken when being impacted or scratched by hard objects such as sand, metal edges etc. and even tend to self-breakage. US20110201490 claimed a glass with B2O3 used to have a high direct impact resistance.

Another important issue accompanied with chemical toughening is the edge strength. The edge strength of (ultra)thin glass is largely defined by CS and the edge treatment. High CS and edge treatment to reduce the edge defect size can lead to high bending strength and small bending radius. The edge defect size can be reduced or removed by mechanical grinding, polishing, chemical etching and combined mechanical and chemical treatment.

Chemical resistance: During glass cleaning, acid or basic detergents are used to remove the contamination on the glass surface. Glass with good acid resistance is rather important to avoid the damage caused by the washing acid. However, especially the acid resistance of used known glasses is unsatisfactory.

Radiation stability (especially solarization resistance and UV blocking): Solarization (transmission decrease of a material caused by exposure to high-energy electromagnetic radiation such as ultraviolet light or X-rays) is an issue for glass. In applications such as consumer displays, OLEDs, photovoltaic cover and organic complementary metal oxide semiconductor (CMOS), the thin glass is a substrate and/or a protective cover glass for organic based material, e.g. an organic functional film layer in an OLED. However, such organic structures are sensitive to electromagnetic radiation, especially in the UV range of less than 300 nm, which can degrade the function of OLED and shorten the lifetime. However, known thin glasses often have not sufficient UV blocking properties for such applications. Furthermore known AS glasses sometimes have a notable color shift due to electromagnetic irradiation, especially due to UV exposure. Thus, the quality of the product decreases during its lifetime due to insufficient solarization stability and insufficient UV blocking.

To sum up, for thin glass suitable to be used for example in a flexible display application which requires thin glass e.g. as a cover, it is quite challenge to solve current problems: 1) high bendability and chemical toughenability, 2) UV blocking and high solarization stability, 3) high acid resistance.

### SUMMARY

Consequently, it is an object of the present invention to overcome the problems of the prior art. Particularly, it is an object of the present invention to provide a thin glass that is chemically toughenable or toughened and which can achieve improved bendability, chemical toughenability and radiation stability. It is a further object of the invention to set evaluation criteria for thin glass having reliable properties for electronic applications.

Glass article: The glass article can be of any size. For example it could be a long thin glass ribbon that is rolled (glass roll), a large glass sheet, a smaller glass part cut out of a glass roll or out of a glass sheet or a single small glass article (like a FPS or display cover glass) etc.

Thickness (t): The thickness of a glass article is the arithmetic average of the thickness of the sample to be measured.

Compressive Stress (CS): The induced compression among glass network after ion-exchange on the surface layer of glass. Such compression could not be released by deformation of glass and sustained as stress. CS decreases from a maximum value at the surface of the glass article (surface CS) towards the inside of the glass article. Commercially available test machine such as FSM6000 surface stress meter produced by Orihara could measure the CS by waveguide mechanism.

Depth of Layer (DoL): The thickness of ion-exchanged layer where CS exists on the surface of glass. Commercially available test machine could measure the DoL by wave guide mechanism. The depths are preferably measured with a surface stress meter, in particular with a FSM 6000 surface stress meter produced by Orihara.

Central Tension (CT): When CS is induced on one side or both sides of single glass sheet, to balance the stress according to the 3rd principle of Newton's law, a tension stress must be induced in the center region of glass, and it is called central tension. CT could be calculated from measured CS and DoL.

E-modulus (E): The E-modulus reflects the material expansion when certain force is applied to the material. It is a measure for the elasticity of the thin glass. The larger the E-modulus, the more difficult the geometry variation will be. Therefore, the glass should have a reasonably high E-modulus in order to resist geometry changes and to keep expansion after chemical toughening low. However, the E-modulus should also not be extraordinarily high so that a certain degree of elasticity is maintained. The E-modulus can be measured with standard methods known in the art. Preferably, it is measured according to DIN 13316:1980-09.

Average roughness (Ra): A measure of the texture of a surface which can be measured with atomic force microscopy (e.g. “Bruker Dimension Icon”). It is quantified by the vertical deviations of a real surface from its ideal form. Commonly amplitude parameters characterize the surface based on the vertical deviations of the roughness profile from the mean line. Ra is arithmetic average of the absolute values of these vertical deviations.

Solarization stability: Calculated from the difference of the Transmission Tr (%) measured before and after UV exposure. UV radiation is applied to the glass samples using a Philips HOK 2000 W lamp at a sample-lamp-distance of 100 mm for 500 h. The transmittance at a defined wavelength (e.g. 350 nm, 400 nm) is measured before and after the radiation and the respective difference is calculated. At the same sample thickness, the lower the transmittance difference, the higher the solarization stability.

UV-blocking. For determining this property the transmission is measured at a wavelength of 300 nm. Samples with different thickness, for example in the range of 70 to 500 μm, were tested to verify the UV-blocking effect.

Acid resistance (S): The acid resistance is measured according to DIN 12116 by testing the resistance of glass samples to attack by boiling hydrochloric acid solution.

Haze: Haze is an optical parameter used for describing scattering properties of a material. It is measured by calculating the ratio of the diffuse/scattered light relative to the total light transmitted by a specimen. Haze=Diffuse transmittance/Total light transmittance. It is obvious that, the more defects on the glass surface, the more light will be scattered, and the value of Haze will be higher. The testing is done according to ISO 13468-1 Standard using a commercial haze meter, e.g. NDH 7000 from Nippon Denshoku. The measurement is done at room temperature by using a sample with the size of 50 mm*50 mm.

### DETAILED DESCRIPTION

The object is solved by chemically toughenable or toughened glass having before chemical toughening a thickness t of at most 500 μm and comprising the following components in wt. % on basis of oxides:

| | |
|---|---|
| SiO2 | 52-66 |
| B2O3 | 0-8 |
| Al2O3 | 15-25 |
| Na2O | 0-20 |
| MgO | 0-6 |
| ZrO2 | 0-2.5 |
| SnO2 | 0.01-1 |
| R2O | 4-30 |
| CeO2 + SnO2 | 0.01-1.5 |
| TiO2 + CeO2 | 0-2.5 |
| Al2O3 + Na2O + MgO + | 16-45 |
| ZrO2 | |

wherein after chemical toughening the glass has a BACT (bendability and chemical toughenability) calculated as BACT=(CS*DoL)/(t*E) which is >0.00050 and/or a NS (normalized stiffness) calculated as NS=CS/E which is >0.0085,

wherein CS is the compressive stress (in MPa) measured at one side of the toughened glass article, DoL (in μm) is the total depth of all ion-exchanged layers on one side of the glass article, t is the thickness of the glass article (in μm), E is the E-modulus (in MPa).

Surprisingly the following was found by the inventors: If a glass or a glass article—in the following specification the term “glass” is also directed to a “glass article”—has a BACT and/or a NS as claimed it has an improved integrated property of bendability and chemical toughenability. CS, DoL and E-modulus are directly influenced by the improved composition of the glass.

BACT is a criterion for the quality of the glass. By means of this criterion it can be decided whether a glass of a defined composition, internal glass structure and thin thickness can reach an optimized stress profile after toughening for desired applications (especially flexible applications). Surprisingly it was found by the inventors, that a glass having the described BACT value meets the industry requirements of a) high bendability to make the flexible article (e.g. display) really flexible and foldable with a glass material—contributed by the reasonable lower E-modulus and thin thickness of the preferably drawn glass—and b) high mechanical strength—enabled by the high CS value—to make the flexible glass article robust enough to resist external impacts like scratching, abrasion, dropping and etc. By achieving such an integrated performance a glass material can reliably be used for flexible applications.—For calculating BACT the product (CS multiplied with DOL) is divided by the product (sample thickness multiplied with E-modulus).

NS is a further criterion for the quality of the glass. NS can sharply describe the glass performance without the factor of thickness, only considering the material itself and the ability of the material to interact with the toughening processing. It indicates, without the factor of thickness, how much contribution from the material itself (represented by E-modulus) can be made to the bendability, and how high CS value can be created on the material (showing how much the material can be toughened, and thus how robust it will be). Obviously, for flexible applications (e.g. flexible display applications), glass with high NS means a high quality/performance glass, more suitable for these applications. Surprisingly it was found by the inventors, that a glass having the described NS value meets the above mentioned industry requirements.—For calculating NS, CS is divided by E-modulus.

To further improve the property of bendability and chemical toughenability of the glass it can be advantageous to select the BACT≥0.00070, preferably >0.00080, more preferably >0.00090, preferred >0.0010, more preferably >0.0015 and/or to preferably select the NS>0.009, preferably >0.010, preferably >0.012, preferably >0.014, more preferably >0.016, also preferably >0.017, preferred >0.018, more preferred >0.019, further preferred >0.020. An advantageous upper limit for BACT can be <0.01, preferably <0.008, preferably <0.006, preferably <0.005. An advantageous upper limit for NS can be <0.040, preferably <0.035.

Advantageously E-modulus can be from 60 to 120 GPa. By means of designing the glass composition, E-modulus is lowered to be preferably <100 GPa, preferably, preferably <90 GPa, preferably <78 GPa, preferably <76 GPa, more preferably <73 GPa, also preferably <71 GPa. Some variants can even have an E-modulus of <70 GPa. Some variants may have an E-modulus of less than 67 GPa. By introducing Al2O3 and/or B2O3 to form AlO4 and BO4 tetrahedra in the networking of SiO4, the strength of the glass network can be loosen, accordingly the E-modulus can be lowered due to the loosened structure. In this invention, reasonable lower E-modulus is envisaged in order to provide glass for flexible and foldable products. However, some advantageous variants can have a higher E-modulus. Here the E-modulus can be <82 GPa, <75 GPa.

For achieving the desired toughenability of the glass according to the invention the content of the sum of Al2O3+Na2O+MgO+ZrO2 is at least 16 wt. %, preferably at least 20 wt. %, preferably at least 25 wt. %, preferably at least 30 wt. %, especially preferably at least 31 wt. %. A preferred upper limit for that sum can be 45 wt. %, preferably 40 wt. % or even 35 wt. %. For some variants it may be advantageous if the content of the sum of Al2O3+Na2O+MgO+ZrO2 is in the range of 30 to 45 wt. %. For other variants it may be advantageous if the content of the sum of Al2O3+Na2O+MgO+ZrO2 is in the range of 16 to 45 wt. %, preferably in the range of 16 to 35 wt. %. If the respective components are chosen in the advantageous range, high CS and low DoL, which are explained in detail below, can be achieved during toughening procedure. Surprisingly, the glass composition according to the invention enables chemically toughening to a high CS value which is advantageous ≥700 MPa, preferably >800 MPa, more preferably >900 MPa, also preferably >1000 MPa, further preferably >1050 MPa to maintain the mechanical strength. In addition the DoL should not be that high anymore. In this case, DoL<30 μm, preferably <20 μm, more preferably <15 μm would be desired.

Solarization resistance (also called solarization stability) of the glass is improved by using a combination of CeO2 and SnO2 (CeO2+SnO2). A lower limit for the sum can be 0.01 wt. %, preferably 0.05 wt. %, preferably 0.1 wt. %, more preferably 0.2 wt. %. An upper limit for the content of the sum can be 1.5 wt. %, preferably 1.25 wt. %. Ce has different valence in the glass as Ce3+ and Ce4+. When the glass gets UV exposed, Ce3+ can be excited to Ce4+, which only influence the spectrum change in the range of UV light, but has no or only little influence on visible light range. This function of Ce3+/Ce4+ change increases the solarization stability dramatically and ensures there is no color shift of the glass. Furthermore, the solarization stability can be even more improved when SnO2 is used with CeO2 together. There may be glass variants which are free of CeO2. If CeO2 is present in the glass composition it is at least 0.01 wt. %, preferably at least 0.1 wt. %, more preferably at least 0.2 wt. % and/or preferably at most 0.5 wt. %, more preferably at most 0.4 wt. %, further preferably at most 0.3 wt. %. In alternative variants it can be advantageous to use CeO2 alone enhancing solarization stability.

In an advantageous embodiment of the invention the glass has a difference of transmission (at a wavelength of 350 nm) measured before and after UV exposure, which is less than 45%, preferably less than 40%, more preferably less than 35%, further preferably less than 30%, preferred less than 20%, even preferred less than 10%. Alternatively or in addition the glass has a difference of transmission (at a wavelength of 400 nm) measured before and after UV exposure, which is less than 10%, preferably less than 7%, more preferably less than 5%, further preferably less than 3%, preferred less than 2%, even preferred less than 1%. Thus the glass has an improved solarization stability. In each case the above cited results can be achieved with glass having a thickness of ≤500 μm, preferably <200 μm, also preferably <150 μm, further preferably <100 μm, further preferably <90 μm, further preferably <80 μm, further preferably <70 μm, further preferably <50 μm, further preferably <30 μm, further preferably <20 μm, further preferably <10 μm.

In order to obtain improved UV blocking, the glass according to the invention advantageously comprises TiO2. TiO2 is used in the glass to cut off the UV light to protect for example an organic film or component underneath and thus to extend the lifespan of a product. If TiO2 is present, its content can be 0.1 wt. %. An upper limit can be 2 wt. %, preferably 1 wt. %. If the content of TiO2 is too high, there is an increasing risk of devitrification. Variants of the glass having less focus on UV blocking can be free of TiO2.

In an advantageous embodiment of the invention UV blocking (e.g. Transmission in %) at a wavelength of 300 nm is <10%, preferably <5%, more preferably <2%, most preferably <1% with glass thickness of ≤500 μm, preferably <200 μm, also preferably <150 μm, further preferably <100 μm, further preferably <90 μm, further preferably <80 μm, further preferably <70 μm, further preferably <50 μm, further preferably <30 μm, further preferably <20 μm, further preferably <10 μm.

Surprisingly it was found by the inventors that the acid resistance of the glass can be improved when the glass advantageously has a sum of ZrO2+Al2O3+TiO2 of at least 15 wt. %, preferably of at least 16 wt. %, more preferable of more than 16 wt. %. However, the content of the sum of ZrO2+Al2O3+TiO2 should not be too high. Preferably an upper limit can be at most 30 wt. %, preferably at most 27 wt. %, preferred at most 24 wt. %.

Further for improving or obtaining the acid resistance and the toughenability, the glass of the present invention advantageously comprises more Na2O than K2O. Thus, preferably the ratio (in wt. %) Na2O/(Na2O+K2O) is >0.4, more preferably >0.5, more preferably >0.6, also preferably >0.7. An advantageous upper limit for Na2O/(Na2O+K2O) is 1.0.

In an advantageous embodiment of the invention acid resistance (given in mg/dm2) is <150, preferably <100, preferably <80, preferably <60, preferably <50, preferably <40, further preferably <30, more preferably <20, more preferably <10. Some advantageous variants may have an acid resistance (given in mg/dm2) of <5, preferably <1.5, more preferably <1, most preferably <0.7.

Advantageously, the glass according to the invention can comprise further components (in wt. % based on oxides):

| | |
|---|---|
| P2O5 | 0-5 |
| Li2O | 0-6 |
| K2O | 0-5 |
| ZnO | 0-4 |
| CaO | 0-5 |
| SrO | 0-1 |
| TiO2 | 0-2 |
| CeO2 | 0-0.5 |
| F | 0-1 |

Further details of the glass composition will be described later.

The glass of the present invention is a thin glass. Preferably, the glass of the present invention has before chemical toughening a thickness of less than or equal to 500 μm, more preferably less than or equal to 400 μm, more preferably less than or equal to 350 μm, more preferably less than or equal to 300 μm, more preferably less than or equal to 200 μm, more preferably less than or equal to 150 μm, more preferably less than or equal to 100 μm, more preferably less than or equal to 75 μm, more preferably less than or equal to 50 μm, more preferably less than or equal to 30 μm, more preferably less than or equal to 25 μm, more preferably less than or equal to 15 μm. However, the glass thickness should not be extremely low because the glass may break too easily. Furthermore, glasses with extremely low thickness may have a limited processability and may be difficult to handle. Preferably, the glass thickness before chemical toughening is higher than 1 μm, more preferably higher than 2 μm.

The glass of the present invention is chemically toughenable or chemically toughened. Compressive stress (CS) and depth of layer (DoL) are parameters that are commonly used in order to describe the chemical toughenability of a glass. To some extent, a glass with highest possibility to achieve highest CS and DoL is expected from the different application fields. However, for a sample with certain thickness, the CS and DoL have to be controlled in a reasonable level. Otherwise, the glass may or will be broken due to too high CT (central tensile stress) in the glass, or the glass will have no mechanical performance advantage if the CS or DoL is too low.

Certain value of achieved CS and/or DoL through chemical toughening is a reflection or recording of the material itself, chemical toughening process conditions, including the salt bath composition, toughening steps, toughening temperature and time. If a usable CS and DoL can be achieved by different possibility of setting temperature and time, then a lower temperature and shorter time will be preferred, which can benefit not only the geometry variation of the glass sheet, but also the production cost. Surprisingly it was found in connection with some preferred variants of the inventive glass material that the toughening time can be chosen to be less than or equal to 120 min, preferably less than or equal to 90 min depending on the glass composition, thickness and DoL to be achieved. Of course there can be other advantageous embodiments having higher toughening times up to 240 min, up to 500 min or even up to 1000 min.

The depth of layer (DoL), indicating the total depth of ion exchange layers on one side of the glass as described above, is preferably more than 1 μm, more preferably more than 3 μm, more preferably more than 5 μm in order to achieve enough mechanical strength of the thin glass. Of course the DoL of a glass article having the composition according to the invention can be more than 15 μm. Especially in cases where the thickness of the glass article is higher, DoL can be preferably more than 50 μm, more preferably more than 70 μm, more preferably more than 75 μm, more preferably more than 100 μm. However, DoL should not be very high in comparison to the glass thickness (t, in μm). Preferably, DoL is less than 0.5*t, more preferably less than 0.3*t, more preferably less than 0.2*t, more preferably less than 0.1*t, wherein t is the thickness of the glass.

The surface compressive stress (CS) can be preferably higher than 0 MPa, more preferably higher than 50 MPa, more preferably higher than 100 MPa, more preferably higher than 200 MPa, more preferably higher than 300 MPa, more preferably higher than 400 MPa, more preferably higher than 500 MPa, more preferably higher than 600 MPa. According to preferred embodiments of the invention CS is equal to or more preferably higher than 700 MPa, more preferably higher than 800 MPa, more preferably higher than 900 MPa, further preferably higher than 1000 MPa. However, CS should not be very high because the glass may otherwise be susceptible to self-breakage. Preferably, CS is equal to or lower than 2000 MPa, preferably equal to or lower than 1600 MPa, advantageously equal to or lower than 1500 MPa, more preferably equal to or lower than 1400 MPa. Some advantageous variants even have a CS of equal to or lower than 1300 MPa or equal to or lower than 1200 Ma.

A chemically toughened glass of the invention is obtained by chemically toughening a chemically toughenable glass according to the invention. The toughening process, also called strengthening, can be done by immersing the glass into a melt salt bath with monovalent ions (such as potassium ions and/or other alkaline metal ions) or by covering the glass with a paste containing monovalent ions and heating the glass at high temperature at certain time. The alkaline metal ions with larger ion radius in the salt bath or the paste exchange with alkaline metal ions with smaller radius in the glass, and surface compressive stress is formed due to ion-exchange. After the ion-exchange, the strength and flexibility of thin glass are significantly improved. In addition, the CS induced by chemical toughening improves the bending properties of the toughened glass article and could increase scratch resistance of glass.

The most used salt for chemical toughening is Na+-contained or K+-contained melted salt or mixture of them. The commonly used salts are NaNO3, KNO3, NaCl, KCl, K2SO4, Na2SO4, Na2CO3, and K2CO3. Additives like NaOH, KOH and other sodium salt or potassium salt could be also used for better controlling the speed of ion-exchange. In the context of the invention it was surprisingly found that very good toughening results can be achieved by using KNO3 and/or CsNO3 either alone or in combination for chemically toughening. Toughening using CsNO3 can be advantageous as the ion radius of Cs+ is bigger than that of K+. Higher CS in the glass can be obtained.

The chemical toughening is not limited to a single step. It can include multi steps in salt bath with alkaline metal ions of different kinds and/or various concentrations to reach better toughening performance. Thus, the chemically toughened glass article according to the invention can be toughened in one step or in the course of several steps, e.g. two steps. According to the invention one step toughening may be preferred.

In addition to the toughening conditions, cooling history (discussed later) and annealing history have an influence on the toughenability of the glass as they influence the density of the glass network. In an preferred embodiment of the invention the chemically toughenable or toughened glass is fine annealed. In the context of the invention fine annealing during glass production can also help the glass to achieve better toughenability performance (especially higher CS) since it can further densify the glass networking in general. When using the finely annealed glass, the CS value can be improved up to >30 MPa, preferably >50 MPa, preferably >100 MPa compared to not finely annealed samples. Fine annealing means, that the annealing speed/rate (the temperature drop from annealing point to room temperature) is <50° C./min, preferably <40° C./min, more preferably <30° C./min, further preferably <10° C./min, also preferably <5° C./min.

For the glass to be easily produced by a drawing process, it is preferable that the temperature difference ΔT between the working temperature T4 (temperature at which the viscosity of the glass is 104 dPas) and the maximum crystallization temperature TOEG is higher than 20 K, preferably higher than 30 K. In preferred embodiments the temperature difference ΔT is higher than 50 K, more preferably higher than 100 K, more preferably higher than 150 K, more preferably higher than 200 K, more preferably higher than 250 K. TOEG can be easily measured by gradient furnace. Gradient furnace means, from one end to the other end of tubing furnace, the temperature can be set from low (e.g. 900° C.) to high (e.g. 1000° C.) in a linear relationship with the distance. When doing the testing, glass particles (especially small cullets in a roughly 3 mm size) are put along the furnace from the low temperature to high temperature, and then hold the furnace temperature for 16 hours. Then at a certain temperature range the glass will be crystallized (e.g. in the range of 981° C. to 1098° C.). In this example here, 1098° C. is the OEG temperature (maximum crystallization/devitrification temperature). For down-draw process, the OEG is expected to be lower than T4, the bigger the difference between T4 and TOEG, the higher the down-drawability of the glass.

It was surprisingly found by the inventors that minimizing the devitrification tendency by reducing MgO and/or adding B2O3 (network former) in the glass composition can help enlarging the difference between T4 and TOEG.

Preferably, the glasses according to the present invention have a maximum crystallization temperature TOEG of <1400° C., preferably <1300° C., more preferably <1200° C. Advantage lower limits can be 700° C., preferably 800° C.

Preferably, the glasses according to the present invention have a working temperature T4 of from 900° C. to 1500° C., more preferably from 1000° C. to 1400° C., more preferably—for special variants—from 1000° C. to 1300° C. or form 1000° C. to 1250° C.

Preferably, the glasses according the present invention have a T7.6 in the range of 700° C. to 1000° C., more preferably from 800° C. to 1000° C.

Preferably, the glasses according the present invention have a T13 in the range of 500° C. to 750° C.

The coefficient of linear thermal expansion (CTE) in the temperature range (20° C.; 300° C.) is a measure of characterizing the expansion behavior of a glass when it experiences certain temperature variation. Therefore, in the temperature range of from 20° C. to 300° C. the glasses of the present invention preferably have a CTE of less than 12 ppm/K, more preferably less than 11.0 ppm/K, more preferably less than 10.0 ppm/K. However, the CTE should also not be very low. Preferably, in the temperature range of from 20° C. to 300° C. the CTE of the glasses of the present invention is more than 5 ppm/K, more preferably more than 6 ppm/K, more preferably more than 7 ppm/K.

Preferably, the glass of the invention has at least one surface with a roughness Ra of less than 5 nm, more preferably less than 2 nm, more preferably less than 1 nm, more preferably less than 0.5 nm.

Advantageous embodiments of the invention have an improved chemical resistance because of the improved glass composition. For determining the chemical resistance polished glass samples were exposed to acid or critical climate conditions in order to intentionally degrade the surface quality. The Haze value measured on glass samples after acid treatment (placing the sample into boiling 6 mol/l HCl for 6 hours, cleaning the surface and drying the sample, then measuring haze) is preferably <90%, preferably <80%, preferably <70%, preferably <60%, more preferably <50%, more preferably <45%. The Haze value measured on glass samples after climate treatment (placing the sample in the climate testing chamber by controlling the humidity (humidity range: ≥50 to ≥90%, 70-90%) and temperature (25-85° C.) for certain time (30 to 365 days) may be <10%, preferably <5%, more preferably <3%, more preferably <1%.

In the present invention, the following glass compositions are chosen for realizing the purposes described above.

SiO2, forming the [SiO4] tetrahedra in the glass, is the most important network former in the glass of the invention. Without SiO2 in the glass, the high mechanical strength and chemical stability of the glasses of the invention cannot be achieved. Therefore, the glasses according to the invention comprise SiO2 in an amount of at least 52 wt. %. More preferably, the glasses comprise SiO2 in an amount of at least 54 wt. %. However, the content of SiO2 in the glass should also not be extremely high because otherwise the meltability may be compromised. The amount of SiO2 in the glass is at most 66 wt. %, preferably at most 65 wt. %, more preferably at most 63 wt. %. In particular preferred embodiments of the invention the content of SiO2 in the glass is from 52 to 66 wt. %, preferably from 54 to 63 wt. %.

[AlO4] tetrahedra can also dramatically enhance the ion-exchange process during the chemical toughening because spaces in the glass networking are enlarged. Moreover, using Al2O3 can also benefit acid resistance a lot. Therefore, Al2O3 is preferably contained in the glasses of the present invention in an amount of at least 15 wt. %, more preferably of at least 16 wt. %. However, the amount of Al2O3 should also not be very high because otherwise the viscosity may be very high so that the meltability may be impaired. Therefore, the content of Al2O3 in the glasses of the present invention is preferably at most 25 wt. %, preferably at most 23 wt. %, more preferably at most 22 wt. %. In particular preferred embodiments of the invention the content of Al2O3 in the glass is from 15 to 25 wt. %, preferably from 15 to 22 wt. %.

Some preferred embodiments comprise B2O3. This component may be used in order to enhance the network by increasing the bridge-oxide in the glass via the form of [BO4] tetrahedra. It also helps to improve the acid resistance of the glass. Furthermore, addition of B2O3 can significantly reduce the E-modulus. By introducing B2O3 together with Al2O3 to form [AlO4] and [BO4] tetrahedra in the networking of SiO4, the strength of the glass network can be loosen, accordingly the E-modulus can be lowered due to the loosened structure. However, B2O3 should not be used in high amounts in the chemically toughenable glass since it can decrease the ion-exchange performance. The glass of the present invention comprises B2O3 in an amount of from 0 to 8 wt. %. In some embodiments of the present invention (low B2O3 variants), the glass preferably comprises at least 0.1 wt. %, more preferably at least 0.5 wt. % B2O3 and/or preferably less than 3 wt. %, preferably at most 2 wt. % B2O3. Alternative advantageous embodiments of the present invention comprise B2O3 in the content range of 3 to 8 wt. % (higher B2O3 variants). Other advantageous variants are B2O3 free.

In some advantageous embodiments of the invention P2O5 may be used in the silicate glass of the invention in order to help lowering the melting viscosity by forming [PO4] tetrahedra, which can significantly lower the melting point without sacrificing anti-crystallization features. Limited amounts of P2O5 do not increase geometry variation very much, but can significantly improve the glass melting and forming performance and the toughening speed. However, if high amounts of P2O5 are used, the chemical stability of the glass may be decreased significantly. Therefore, the glasses of the present invention comprise P2O5 in an amount of from 0 to 5 wt. %, preferably from 1 to 4.5 wt. %. In some embodiments of the present invention, the glass preferably comprises at least 0.5 wt. %, more preferably at least 1 wt. %. An advantageous upper limit for P2O5 can be 5 wt. %, preferably 4.5 wt. %, more preferably 4 wt. %. Alternatively there are advantageous embodiments of the invention which are free of P2O5.

TiO2 can also form [TiO4] and can thus help building up the network of the glass, and can also be beneficial for improving the acid resistance of the glass. However, the amount of TiO2 in the glass should not be very high. TiO2 present in high concentrations may function as a nucleating agent and may thus result in crystallization during manufacturing. TiO2 also can be used as UV cut off agent, especially for UV absorption in the spectrum equal to or lower than 300 nm. Preferably, the content of TiO2 in the glasses of the invention is from 0 to 2 wt. %, preferably from 0 to 1 wt. %. If TiO2 is present, its content can be 0.1 wt. %. An upper limit can be 2 wt. %, preferably 1 wt. %. Variants of the glass can be free of TiO2, for example if another component having UV blocking properties is present in the glass composition.

ZrO2 has the function of improving CS and acid resistance of the glass. Preferably, the content of ZrO2 in the glasses of the invention is from 0 to 2.5 wt. %. In some embodiments of the present invention, the glass preferably comprises at least 0.1 wt. %, preferably at least 0.2 wt. %, preferably 0.3 wt. %, preferably 0.4 wt. %, more preferably at least 0.5 wt. %. An upper limit can be 2.5 wt. %, preferably 2 wt. %, preferably 1.5 wt. %. Some advantageous variants are free of ZrO2.

Alkaline oxides R2O (Na2O+K2O+Cs2O (+Li2O)) are used as network modifiers to supply sufficient oxygen anions to form the glass network, which helps increasing CTE of the glass and then decreasing E-modulus. In advantageous embodiments of the invention, which may be preferably fee of Li2O, the content of R20 in the glasses of the invention can be at least 10 wt. %, more preferably at least 12 wt. %. However, the content of R20 in the glasses of the invention should not be very high because otherwise chemical stability may be impaired. Preferably, the glasses of the invention comprise R20 in an amount of at most 30 wt. %, preferably at most 26 wt. %, preferably at most 23 wt. %, preferably at most 21 wt. %. Advantageously these embodiments have R20 in the range of 10 to 30 wt. %, preferably 10 to 26 wt. %, more preferably 10 to 23 wt. %.

Other advantageous embodiments of the invention can comprise Li2O. Since the size of Li+ is much lower than that of K+, Li+ in the glass can help increasing the CS value. Here the content of R20 (Na2O+K2O+Cs2O+Li2O) is preferably at least 4 wt. %, more preferably at least 5 wt. %. An upper limit for R20 in these variants can be less than 30 wt. %, preferably less than 29 wt. %. Thus an advantageous R20 range for the sum can be 4 to 30 wt. %, preferably 4 to 29 wt. %, also preferably 4 to 25 wt. %, further preferably 4 to 20 wt. %.

Li2O can be contained in the glass composition in the range of 0 to 6 wt. %, preferably 0.5 to 5 wt. %. If it is present a lower limit can be 0.1 wt. %, preferably 0.5 wt. %, more preferably 1 wt. %. An advantageous upper limit can be 5 wt. % or 4 wt. %. Li2O can help improving the E-modulus and lowering CTE of the glass. Li2O also influences the ion-exchange greatly.

Na2O may be used as a network modifier. However, the content of Na2O should not be very high because otherwise chemical stability and chemical toughenability may be impaired. Preferably, the content of Na2O in the glasses of the invention is from 0 to 20 wt. %, preferably 0 to 17 wt. %. Further advantageous lower limits can be 1 wt. %, preferably 2 wt. %, preferably 4 wt. %, preferably 7 wt. %, preferably 10 wt. %, preferably 11 wt. %. Preferred upper limits can be 20 wt. %, preferably 17 wt. %, also preferably 15 wt. %. In some advantageous embodiments the content of Na2O is from 10 to 20 wt. In other advantageous embodiments (preferably having a lower sum of R20) the content of Na2O is from 0 to 15 wt. %. Advantageous upper limits of that component can be 13 wt. %, preferably 10 wt. %, preferably 6 wt. %. Advantageous lower limits can be 0.5 wt. %, preferably 1 wt. %. Na2O free variants are also possible.

K2O may be used as a network modifier. However, the content of K2O should not be very high because otherwise chemical stability and chemical toughenability may be impaired. Preferably, the content of K2O in the glasses of the invention is from 0 to 5 wt. %. Preferable upper limits can be 4 wt. %, preferred 3 wt. %, more preferred 2 wt. %. A lower limit for K2O can be 0.1 wt. % or 0.3 wt. %. K2O free variants are also possible.

Using both K2O and Na2O together can have an “alkaline mixture” effect, which helps increasing the acid resistance. Acid resistance depends on the ion-exchange rate between H+(from acid) and alkaline metal ions in the glass. When using both K+ and Na+ together, ion-exchange rate of Na+ or K+ is depressed by each other, resulting in a low loss of glass weight. Thus the acid resistance of the glass is improved.

The glasses of the present invention may also comprise alkaline earth metal oxides as well as ZnO which are collectively termed “RO” in the present specification. Alkaline earth metals and Zn may serve as network modifiers. Preferably, the glasses of the present comprise RO in an amount of from 0 to 16 wt. %. In some embodiments of the present invention, the glass preferably comprises at least 0.5 wt. %, more preferably at least 1 wt. %, more preferably at least 2 wt. % of RO. An advantageous upper limit for RO can be less than 15 wt. %, preferably less than 14 wt. %

Preferred alkaline earth metal oxides are selected from the group consisting of MgO, CaO, SrO und BaO. More preferably, alkaline earth metals are selected from the group consisting of MgO und CaO. More preferably, the alkaline earth metal can be preferred MgO in advantageous embodiments of the invention.

Preferably, the glass of the invention comprises MgO in an amount of from 0 to 6 wt. %, preferably 0 to 4 wt. %. In some embodiments of the present invention, the glass preferably comprises at least 0.5 wt. %, more preferably at least 1 wt. %, more preferably at least 1.5 wt. % of MgO. An advantageous upper limit for MgO can be 6 wt. %, preferably 4 wt. %, further preferably 3 wt. %. MgO is beneficial for achieving high CS, but harmful as far as devitrification is regarded. MgO free variants are also possible.

Preferably, the glass of the invention comprises ZnO in an amount of from 0 to 4 wt. %, preferably 0 to 2 wt. %. In some embodiments of the present invention, the glass preferably comprises at least 0.1 wt. %, more preferably at least 0.5 wt. % of ZnO. An advantageous upper limit for ZnO can be 4 wt. %, preferably 3 wt. %, more preferably 2 wt. %. ZnO free variants are also possible.

Some advantageous variants of the invention can comprise CaO. If it is present, the CaO content is at least 0.1 wt. %, preferably at least 0.5 wt. %. An advantageous upper limit for CaO can be 5 wt. %, preferably 4 wt. %. However, embodiments being free of CaO may be preferred for some applications.

Some advantageous variants of the invention can comprise SrO. If it is present the SrO content is at least 0.1 wt. %, preferably at least 0.5 wt. %. An advantageous upper limit for SrO can be 1 wt. %.

Preferably, the content of SnO2 in the glasses of the present invention is from 0.01 to 1 wt. %. This component helps to improve the solarization stability and works as an refining agent. However, an upper limit of 1 wt. %, preferably 0.7 wt. %, more preferably 0.5 wt. % should not be exceeded because residual gas bubble created by refining agent may remain in the melted glass, which is harmful to the refining effect. Advantageous lower limits of that component can be 0.05 wt. %, preferably 0.1 wt. %, preferably 0.2 wt. %.

Preferably, the content of CeO2 in the glasses of the present invention is from 0 to 0.5 wt. %. Advantages and preferred ranges for that component has already been described above.

SnO2 and CeO2 can be used in the glass, which helps improving the solarization stability of the glass. The photo-reaction of Ce3+ and Ce4+ happens at the wavelength of about 280-320 nm, which does not influence the visible light range and helps the solarization stability without colorization. Further advantages and preferred ranges for the sum of (SnO2+CeO2) has already been described above.

TiO2 in combination with CeO2 are advantageous for improving UV blocking properties of the glass. Preferably, the content of the sum of (TiO2+CeO2) is from 0 to 2.5 wt. %. An advantage lower limit for that sum can be 0.1 wt. %, preferably 0.2 wt. %, preferably 0.5%. An advantageous upper limit for that sum can be 2.5 wt. %, preferably 2 wt. %, preferably 1.6 wt. %, preferably 1.1 wt. %.

Preferably, the glass of the invention comprises F in an amount of from 0 to 1 wt. %. In some embodiments of the present invention, the glass preferably comprises at least 0.1 wt. %. F can break the networking of the glass, which leads to a decrease of the melting temperature and to a decrease of the E-modulus. An advantageous upper limit for F can be 0.5 wt. %, preferably 0.3 wt. %. But the amount of F could not be too much, otherwise the glass networks are broken too much and the glass will get devitrification easily, which is harmful to the manufacturing process (preferably drawing process, preferred down drawing process). Some variants of the invention are preferably free of F.

In preferred embodiments, the glass consists of the components mentioned in the present specification to an extent of at least 95%, more preferably at least 97%, most preferably at least 99%. In most preferred embodiments, the glass essentially consists of the components mentioned in the present specification.

The terms “X-free” and “free of component X”, respectively, as used herein, preferably refer to a glass, which essentially does not comprise said component X, i.e. such component may be present in the glass at most as an impurity or contamination, however, is not added to the glass composition as an individual component. This means that the component X is not added in essential amounts. Non-essential amounts according to the present invention are amounts of less than 100 ppm, preferably less than 50 ppm and more preferably less than 10 ppm. Preferably, the glasses described herein do essentially not contain any components that are not mentioned in this description.

In accordance with the present invention is also a method for producing a glass of the present invention comprising the steps of: providing a composition, melting the composition, and producing a glass in a flat glass process.

The glass composition that is provided according to step a) is a composition that is suitable for obtaining a glass of the present invention.

Flat glass processes are well known to the skilled person. According to the present invention, the flat glass processes are preferably selected from the group consisting of pressing, down-draw, redraw, overflow fusion, floating and rolling. Direct hot-forming production like down draw or overflow fusion method are preferred flat glass processes in the context of the invention. Redraw method may be also advantageous. These mentioned methods are economical, the glass surface quality is high and thin glass with thickness from 5 μm (or even less) to 500 μm could be produced. For example, the down-draw/overflow fusion method could make pristine or fire-polished surface with roughness Ra less than 5 nm, preferred less than 2 nm, even preferred less than 1 nm. The thickness could also be precisely controlled ranging from 5 μm and 500 μm.

During the drawing process the cooling rate in the temperature region around the annealing point of the glass, in particular the temperature region corresponding to a glass viscosity of 1010 dPas to 1015 dPas should be controlled as it influences the density of the glass network. Preferably, the average cooling rate in the temperature region corresponding to a glass viscosity of 1010 dPas to 1015 dPas is higher than 5° C./s, more preferably higher than 10° C./s, more preferably higher than 30° C./s, more preferably higher than 50° C./s, more preferably higher than 100° C./s. Preferably, the average cooling rate in the temperature region corresponding to a glass viscosity of 1010 dPas to 1015 dPas is lower than 200° C./s. Within the present specification the terms “dPas” and “dPa's” are used interchangeably.

In the context of the invention fine annealing during glass production is an advantageous measure to help the glass to achieve better toughenability performance (especially higher CS) since it can further densify the glass networking in general. By using fine annealing the CS value—that can be achieved in the glass—can be improved up to >30 MPa, preferably >50 MPa, preferably >100 MPa compared to not finely annealed samples. Fine annealing means, that the annealing speed (the temperature drop from annealing point to room temperature) is advantageous <50° C./min, preferably <40° C./min, more preferably <30° C./min, further preferably <10° C./min, also preferably <5° C./min.

Both well selected cooling rate and fine annealing rate influence the network of the glass and improve the toughenability of the thin glass.

The manufacturing method may optionally comprise further steps. Further steps may be for example chemically toughen the glass. Preferably, chemical toughening is done in a salt bath, in particular in a bath of molten salt. The glass of the invention is preferably toughened with Na, K or Cs nitrate, sulfate or chloride salts or a mixture of one or more thereof as a toughening agent. More preferably, the glass of the invention is toughened with NaNO3 or KNO3 or both KNO3 and NaNO3 as toughening agents. More preferably, chemical toughening comprises at least one toughening step comprising toughening in a toughening agent comprising KNO3. More preferably, the glass of the invention is toughened with KNO3 only or with CsNO3 only as toughening agents. Of course toughening with both KNO3 and CsNO3 as toughening agents is possible. In embodiments in which chemical toughening is done with KNO3 only or with CsNO3 only, chemical toughening is preferably done in a single step. The same may apply to variants in which chemical toughening is done with NaNO3 only.

If the toughening temperature is very low, the toughening rate will be low. Therefore, chemical toughening is preferably done at a temperature of more than 320° C., more preferably more than 350° C., more preferably more than 380° C., more preferably at a temperature of at least 400° C. However, the toughening temperature should not be very high because very high temperatures may result in strong CS relaxation and low CS. Preferably, chemical toughening is done at a temperature of less than 500° C., more preferably less than 450° C.

As described above, chemical toughening is preferably either done in a single step or in multiple steps, in particular in two steps. If the duration of toughening is very low, the resulting DoL may be very low. If the duration of toughening is very high, the CS may be relaxed very strongly. The duration of each toughening step is preferably between 0.01 and 20 hours, more preferably between 0.05 and 16 hours, more preferably between 0.1 and 10 hours, more preferably between 0.2 and 6 hours, more preferably between 0.5 and 4 hours. The total duration of chemical toughening, in particular the sum of the duration of the two separate toughening steps, is preferably between 0.01 and 20 hours, more preferably between 0.2 and 20 hours.

Advantageous chemically toughening results (CS, DoL etc.) have already been described above.

The glass according to the invention may be used in the field of industrial and consumer displays, OLEDs, photovoltaic cover and organic complementary metal oxide semiconductor (CMOS), especially in applications where flexible properties are required (e.g. flexible display cover). It can be used in all types of flash lights and lighting, in particular in mobile devices. The glass may also be used as cover glass and/or sealing glass of OLEDs and also as device cover on displays and as a non-display cover, in particular as cover glass for finger print sensors. It can be used as protective cover film, camera module, foldable display, flexible display and for other electronic devices.

### EXAMPLES

Example glasses were prepared and some properties were measured. The glass compositions tested can be seen in tables 1 to 3 below.

### Composition Examples

The following TABLES 1 to 3 show exemplary glass compositions in wt. %. which are representative examples of the present invention.

TABLE 1
Glass compositions (glasses S1 to S7)

| | Glass | | | | | | |
|---|---|---|---|---|---|---|---|
| | S1 | S2 | S3 | S4 | S5 | S6 | S7 |
| | wt % | wt % | wt % | wt % | wt % | wt % | wt % |
| SiO2 | 61.0 | 61.0 | 61.0 | 55.0 | 61.2 | 58.0 | 61.0 |
| B2O3 | 0 | 0 | 0 | 0 | 0 | 0 | 0 |
| Al2O3 | 16.9 | 16.2 | 16.9 | 16.9 | 16.9 | 16.8 | 16.9 |
| Na2O | 12.5 | 14.9 | 14.9 | 17.0 | 14.1 | 14.9 | 15.0 |
| K2O | 4.2 | 2.0 | 2.0 | 5.0 | 3.6 | 3.1 | 2.5 |
| MgO | 3.9 | 2.5 | 2.5 | 3.3 | 1.0 | 2.5 | 2.0 |
| ZrO2 | 1.0 | 0 | 0.8 | 0.3 | 1.0 | 0.4 | 0 |
| F | 0.3 | 0.3 | 0.3 | 0.4 | 0.3 | 0.7 | 0.3 |
| SnO2 | 0.25 | 1.00 | 0.25 | 0.25 | 0.25 | 0.25 | 0.25 |
| ZnO | 0 | 2.0 | 0.8 | 0.9 | 0 | 3.0 | 1.0 |
| TiO2 | 0 | 0 | 0.5 | 0.8 | 1.5 | 0.3 | 1.0 |
| CeO2 | 0 | 0.1 | 0.1 | 0.1 | 0.1 | 0.1 | 0.1 |
| (CeO2 + SnO2) | 0.25 | 1.10 | 0.35 | 0.35 | 0.35 | 0.35 | 0.35 |
| (TiO2 + CeO2) | 0 | 0.1 | 0.6 | 0.9 | 1.6 | 0.4 | 1.1 |
| Na2O/(Na2O + K2O) | 0.7 | 0.9 | 0.9 | 0.8 | 0.8 | 0.8 | 0.9 |
| (ZrO2 + Al2O3 + TiO2) | 17.9 | 18.2 | 18.4 | 18.2 | 17.9 | 20.2 | 17.9 |
| (Al2O3 + Na2O + MgO + ZrO2) | 34.3 | 33.6 | 35.1 | 37.6 | 33.0 | 34.6 | 33.9 |

TABLE 2
Glass compositions (glasses S8 to S14)

| | Glass | | | | | | |
|---|---|---|---|---|---|---|---|
| | S8 | S9 | S10 | S11 | S12 | S13 | S14 |
| | wt % | wt % | wt % | wt % | wt % | wt % | wt % |
| SiO2 | 61.0 | 60.6 | 61.0 | 61.0 | 63.0 | 59.0 | 55.7 |
| B2O3 | 0 | 0 | 0 | 0 | 0 | 0 | 3.6 |
| Al2O3 | 16.9 | 16.5 | 16.8 | 16.6 | 15.0 | 19.0 | 17.8 |
| Na2O | 14.9 | 14.9 | 17.0 | 13.5 | 15.0 | 16.5 | 15.5 |
| K2O | 2.0 | 2.2 | 1.0 | 4.2 | 2.5 | 1.8 | 0.7 |
| MgO | 2.5 | 2.5 | 1.5 | 2.9 | 2.3 | 0.5 | 3.3 |
| ZrO2 | 1.4 | 2.0 | 0.8 | 0.2 | 1.0 | 1.0 | 2.5 |
| F | 0.3 | 0.3 | 0.3 | 0.3 | 0.3 | 0.1 | 0.2 |
| SnO2 | 0.25 | 0.90 | 0.25 | 0.50 | 0.25 | 0.25 | 0.40 |
| ZnO | 0.4 | 0 | 0.4 | 0.8 | 0 | 1.3 | 0 |
| TiO2 | 0.3 | 0 | 0.8 | 0 | 0.3 | 0.4 | 0.1 |
| CeO2 | 0.1 | 0.1 | 0.1 | 0 | 0.4 | 0.2 | 0.2 |
| (CeO2 + SnO2) | 0.35 | 1.00 | 0.35 | 0.50 | 0.65 | 0.45 | 0.55 |
| (TiO2 + CeO2) | 0.4 | 0.1 | 0.9 | 0 | 0.7 | 0.6 | 0.3 |
| Na2O/(Na2O + K2O) | 0.9 | 0.9 | 0.9 | 0.8 | 0.9 | 0.9 | 1.0 |
| (ZrO2 + Al2O3 + TiO2) | 18.7 | 18.5 | 18.0 | 17.6 | 16.0 | 21.3 | 20.3 |
| (Al2O3 + Na2O + MgO + ZrO2) | 35.7 | 35.9 | 36.1 | 33.2 | 33.3 | 37.0 | 39.1 |

TABLE 3
Glass compositions (glasses S15 to S21)

| | Glass | | | | | | |
|---|---|---|---|---|---|---|---|
| | S15 | S16 | S17 | S18 | S19 | S20 | S21 |
| | wt % | wt % | wt % | wt % | wt % | wt % | wt % |
| SiO2 | 63.0 | 61.0 | 59.0 | 57.0 | 57.5 | 65.0 | 63.0 |
| B2O3 | 3.0 | 4.6 | 5.0 | 6.0 | 7.2 | 3.7 | 5.0 |
| Al2O3 | 17.8 | 19.6 | 21.2 | 21.0 | 22.0 | 17.7 | 17.7 |
| Na2O | 13.0 | 12.1 | 12.0 | 11.0 | 13.0 | 1.1 | 4.2 |
| K2O | 0 | 0.9 | 1.0 | 3.5 | 0 | 0.3 | 0.3 |
| MgO | 1.0 | 1.2 | 1.2 | 1.2 | 0 | 0 | 2.0 |
| ZrO2 | 0.9 | 0 | 0 | 0 | 0 | 0.7 | 0.3 |
| F | 0.3 | 0.1 | 0.1 | 0.1 | 0 | 0.1 | 0.1 |
| SnO2 | 0.20 | 0.20 | 0.20 | 0.22 | 0.20 | 0.4 | 0.4 |
| ZnO | 0 | 0.1 | 0.1 | 0 | 0 | 0.5 | 0.5 |
| TiO2 | 0.6 | 0 | 0 | 0.1 | 0 | 0 | 0.1 |
| CeO2 | 0.3 | 0.2 | 0.2 | 0 | 0.1 | 0.5 | 0.5 |
| P2O5 | | | | | | 1.4 | 4.0 |
| CaO | | | | | | 4.0 | 0 |
| SrO | | | | | | 0.6 | 0 |
| Li2O | | | | | | 4.1 | 2.0 |
| (CeO2 + SnO2) | 0.45 | 0.40 | 0.40 | 0.22 | 0.30 | 0.90 | 0.90 |
| (TiO2 + CeO2) | 0.9 | 0.2 | 0.2 | 0.1 | 0.1 | 0.5 | 0.6 |
| Na2O/(Na2O + K2O) | 1.0 | 0.9 | 0.9 | 0.8 | 1.0 | 0.8 | 0.9 |
| (ZrO2 + Al2O3 + TiO2) | 18.7 | 19.7 | 21.3 | 21.0 | 22.0 | 18.9 | 18.5 |
| (Al2O3 + Na2O + MgO + ZrO2) | 32.7 | 33.0 | 34.4 | 33.2 | 35.0 | 19.5 | 24.2 |

The compositions given above in tables 1 to 3 are the final compositions measured in the glass. The skilled person knows how to obtain these glasses by melting the necessary raw materials.

Producing and Chemical Toughening of Glasses

Glasses were produced by down draw using suitable raw materials to obtain the final compositions shown in tables 1 to 3. The average cooling rate in the temperature region corresponding to a glass viscosity of 1010 dPas to 1015 dPas was 50° C./s. The glasses had the properties as shown in the following tables.

TABLE 4
Properties 1 (glasses S1 to S7)

| Glass | S1 | S2 | S3 | S4 | S5 | S6 | S7 |
|---|---|---|---|---|---|---|---|
| thickness (μm) for | 150 | 150 | 150 | 150 | 150 | 150 | 150 |
| testing transmiss.(Tr) | | | | | | | |
| Tr (300 nm) | 0% | 0% | 0% | 0% | 0% | 0% | 0% |
| Tr (350 nm) before | 91% | 89% | | | 86% | | |
| solarization | | | | | | | |
| Tr (350 nm) after | 56% | 69% | | | 68% | | |
| solarization | | | | | | | |
| Tr diff. (350 nm), | 35% | 20% | | | 18% | | |
| before-after solariz. | | | | | | | |
| Tr(400 nm) before | 92% | 92% | | | 92% | | |
| solarization | | | | | | | |
| Tr (400 nm) after | 90% | 91% | | | 91% | | |
| solarization | | | | | | | |
| Tr diff. (400 nm), | 2% | 1% | | | 1% | | |
| before-after solariz. | | | | | | | |
| E-modulus (GPa) | 73.30 | 71.87 | 72.29 | 71.03 | 72.42 | 72.03 | 71.93 |
| Density @20° C. | 2.49 | 2.51 | 2.50 | 2.55 | 2.49 | 2.52 | 2.49 |
| (g/cm3) | | | | | | | |
| CTE (ppm/K) | 8.9 | 9.2 | 9.1 | 9.1 | 9.2 | 9.6 | 9.3 |
| T4 (° C.) | 1142 | 1144 | 1142 | 1043 | 1137 | 1120 | 1166 |
| T7.6 (° C.) | 874 | 843 | 848 | 784 | 841 | 835 | 836 |
| T13 (° C.) | 614 | 579 | 586 | 549 | 585 | 577 | 578 |
| T OEG (° C.) | 1100 | no | no | 908 | 1021 | no | 890 |
| | | devitrific. | devitrific. | | | devitrific. | |
| ΔT = T4 − T OEG (° C.) | 42 | | | 135 | 116 | | 276 |
| T4 − T7.6 (° C.) | 268 | 301 | 294 | 259 | 296 | 285 | 330 |
| S (acid resist., DIN | 36 | 30 | 25 | 24 | 20 | 15 | 35 |
| 12116) (mg/dm2) | | | | | | | |
| Sample thickness | 0.2 | 0.2 | | 0.3 | 0.1 | | |
| testing Haze (mm) | | | | | | | |
| Haze (testing | 70% | 70% | | 6 mol/L | 90% | | |
| conditions) | humidity, | humidity, | | HCL, | humidity, | | |
| | 25° C., | 25° C.; | | boiling | 35° C., | | |
| | 365 days | 365 days | | for 6 | 100 days | | |
| | storage | storage | | hours | storage | | |
| Haze value (%) | 0.12 | 0.11 | | 41.00 | 0.10 | | |

TABLE 5
Properties 1 (glasses S8 to S14)

| Glass | S8 | S9 | S10 | S11 | S12 | S13 | S14 |
|---|---|---|---|---|---|---|---|
| thickness (μm) for | 150 | 150 | 150 | 70 | 500 | 150 | 300 |
| testing Transmiss.(Tr) | | | | | | | |
| Tr (300 nm) | 0% | 0% | 0% | 0% | 0% | 0% | 0% |
| Tr (350 nm) before | | 89% | | 91% | 87% | 87% | 87% |
| solarization | | | | | | | |
| Tr (350 nm) after | | 74% | | 56% | 72% | 70% | 69% |
| solarization | | | | | | | |
| Tr. Diff. (350 nm), | | 15% | | 35% | 15% | 17% | 18% |
| before-after solariz. | | | | | | | |
| Tr. (400 nm) before | | 92% | | 92% | 92% | 92% | 92% |
| solarization | | | | | | | |
| Tr (400 nm) after | | 91% | | 90% | 91% | 91% | 91% |
| solarization | | | | | | | |
| Tr diff. (400 nm), | | 1% | | 2% | 1% | 1% | 1% |
| before-after solariz. | | | | | | | |
| E-modulus (GPa) | 72.59 | 72.27 | 71.23 | 70.20 | 71.08 | 70.86 | 74.33 |
| Density @20° C. | 2.49 | 2.51 | 2.50 | 2.49 | 2.49 | 2.51 | 2.53 |
| (g/cm3) | | | | | | | |
| CTE (ppm/K) | 9.0 | 9.1 | 9.6 | 9.4 | 9.2 | 9.6 | 8.7 |
| T4 (° C.) | 1151 | 1153 | 1127 | 1139 | 1128 | 1184 | 1174 |
| T7.6 (° C.) | 850 | 845 | 826 | 849 | 828 | 854 | 879 |
| T13 (° C.) | 587 | 585 | 569 | 585 | 570 | 580 | 639 |
| T OEG (° C.) | no | no | no | no | no | no | no |
| | devitrific. | devitrific. | devitrific. | devitrific. | devitrific. | devitrific | devitrific. |
| ΔT = T4 − T OEG (° C.) | | | | | | | |
| T4 − T7.6 (° C.) | 301 | 308 | 301 | 290 | 300 | 330 | 295 |
| S (acid resist., DIN | 18 | 20 | 31 | 37 | 39 | 7 | 6 |
| 12116) (mg/dm2) | | | | | | | |
| Sample thickness for | | 0.1 | | | | | 0.5 |
| testing Haze (mm) | | | | | | | |
| Haze (testing | | 6 mol/L | | | | | 70% |
| conditions) | | HCL, | | | | | humidity |
| | | boiling | | | | | 25° C., |
| | | for 6 | | | | | 365 days |
| | | hours | | | | | storage |
| Haze value (%) | | 38.00 | | | | | 0.10 |

TABLE 6
Properties 1 (glasses S15 to S21)

| Glass | S15 | S16 | S17 | S18 | S19 | S20 | S21 |
|---|---|---|---|---|---|---|---|
| thickness (μm) for | 150 | 150 | 150 | 150 | 150 | 150 | 150 |
| testing Transmiss.(Tr) | | | | | | | |
| Tr (300 nm) | 0% | 0% | 0% | 0% | 0% | 0% | 0% |
| Tr (350 nm) before | | | | 90% | | | 87% |
| solarization | | | | | | | |
| Tr (350 nm) after | | | | 65% | | | 72% |
| solarization | | | | | | | |
| Tr diff. (350 nm), | | | | 25% | | | 15% |
| before-after solariz. | | | | | | | |
| Tr (400 nm) before | | | | 92% | | | 92% |
| solarization | | | | | | | |
| Tr (400 nm) after | | | | 91% | | | 91% |
| solarization | | | | | | | |
| Tr diff. (400 nm), | | | | 1% | | | 1% |
| before-after solariz. | | | | | | | |
| E-modulus (GPa) | 72.70 | 69.25 | 68.08 | 67.00 | 64.00 | 80.00 | 73.00 |
| Density @20° C. | 2.51 | 2.43 | 2.44 | 2.45 | 2.45 | 2.40 | 2.41 |
| (g/cm3) | | | | | | | |
| CTE (ppm/K) | 7.3 | 7.4 | 7.4 | 7.8 | 7.4 | 5.3 | 6.0 |
| T4 (° C.) | 1134 | 1140 | 1145 | 1145 | 1120 | 1200 | 1400 |
| T7.6 (° C.) | 901 | 910 | 923 | 930 | 920 | 820 | 900 |
| T13 (° C.) | 705 | 720 | 736 | 730 | 730 | 585 | 630 |
| T OEG (° C.) | 900 | no | no | no | no | 1030 | 1100 |
| | | devitrific. | devitrific. | devitrific. | devitrific. | | |
| ΔT = T4 − T OEG (° C.) | 234 | | | | | 170 | 300 |
| T4 − T7.6 (° C.) | 233 | 230 | 222 | 215 | 200 | | |
| S (acid resist., DIN | 6 | 3 | 3 | 1 | 1 | 10 | 20 |
| 12116) (mg/dm2) | | | | | | | |
| Sample thickness for | | | 0.1 | 0.4 | 0.1 | 0.1 | |
| testing Haze (mm) | | | | | | | |
| Haze (testing | | | 85% | 6 mol/L | 70% | 6 mol/L | |
| conditions) | | | humidity | HCL, | humidity | HCL, | |
| | | | 85° C., | boiling | 25° C., | boiling | |
| | | | 30 days | for 6 | 365 days | for 6 | |
| | | | storage | hours | storage | hours | |
| Haze value (%) | | | 0.09 | 1.00 | 0.10 | 30.00 | |

TABLE 7
Properties 2 (glasses S1 to S7)

| Glass | S1 | S2 | S3 | S4 | S5 | S6 | S7 |
|---|---|---|---|---|---|---|---|
| thickness (μm) for | 200 | 70 | 200 | 150 | 500 | 200 | 400 |
| toughen., BACT, NS | | | | | | | |
| toughening temp. (° C.) | 400 | 400 | 400 | 400 | 420 | 400 | 400 |
| toughening time (min) | 40 | 40 | 40 | 40 | 120 | 40 | 240 |
| toughening agent | 100 | 100 | 100 | 100 | 100 | 100 | 100 |
| KNO3 (mol %) | | | | | | | |
| toughening agent | 0 | 0 | 0 | 0 | 0 | 0 | 0 |
| CsNO3 (mol %) | | | | | | | |
| CS (MPa) | 1011 | 1055 | 1142 | 1150 | 1020 | 1130 | 1100 |
| Dol (μm) | 10.2 | 8.5 | 9.1 | 9.3 | 27 | 9.4 | 23 |
| BACT = CS*DoL/(t*E) | 0.00070 | 0.00178 | 0.00072 | 0.00100 | 0.00076 | 0.00074 | 0.00088 |
| NS = CS/E | 0.014 | 0.015 | 0.016 | 0.016 | 0.014 | 0.016 | 0.015 |

TABLE 8
Properties 2 (glasses S8 to S14)

| Glass | S8 | S9 | S10 | S11 | S12 | S13 | S14 |
|---|---|---|---|---|---|---|---|
| thickness (μm) for | 200 | 200 | 200 | 350 | 150 | 300 | 180 |
| toughen., BACT, NS | | | | | | | |
| toughening | 400 | 400 | 400 | 390 | 400 | 400 | 400 |
| temp. (° C.) | | | | | | | |
| toughening time | 40 | 40 | 40 | 300 | 40 | 120 | 90 |
| (min) | | | | | | | |
| toughening agent | 100 | 100 | 100 | 99 | 100 | 100 | 100 |
| KNO3 (mol %) | | | | | | | |
| toughening agent | 0 | 0 | 0 | 1 | 0 | 0 | 0 |
| CsNO3 (mol %) | | | | | | | |
| CS (MPa) | 1152 | 1200 | 1250 | 1172 | 1160 | 1030 | 1290 |
| Dol (μm) | 9.2 | 9.1 | 10 | 26 | 9.2 | 19 | 13 |
| BACT = CS*DoL/(t*E) | 0.00073 | 0.00076 | 0.00088 | 0.00124 | 0.00100 | 0.00092 | 0.00125 |
| NS = CS/E | 0.016 | 0.017 | 0.018 | 0.017 | 0.016 | 0.015 | 0.017 |

TABLE 9
Properties 2 (glasses S15 to S21)

| Glass | S15 | S16 | S17 | S18 | S19 | S20 | S21 |
|---|---|---|---|---|---|---|---|
| thickness (μm) for | 180 | 200 | 200 | 200 | 200 | 100 | 50 |
| toughen., BACT, NS | | | | | | | |
| toughening | 400 | 400 | 400 | 400 | 400 | 390 | 390 |
| temperature (° C.) | | | | | | | |
| toughening time | 60 | 90 | 90 | 90 | 90 | 480 | 960 |
| (min) | | | | | | | |
| toughening agent | 100 | 100 | 100 | 100 | 100 | 100 | 100 |
| KNO3 (mol %) | | | | | | | |
| toughening agent | 0 | 0 | 0 | 0 | 0 | 0 | 0 |
| CsNO3 (mol %) | | | | | | | |
| CS (MPa) | 1090 | 1250 | 1310 | 1300 | 1320 | 1500 | 1230 |
| Dol (μm) | 12 | 13.5 | 14.6 | 13.8 | 13.4 | 4 | 6 |
| BACT = CS*DoL/(t*E) | 0.00100 | 0.00122 | 0.00140 | 0.00134 | 0.00138 | 0.00075 | 0.00202 |
| NS = CS/E | 0.015 | 0.018 | 0.019 | 0.019 | 0.021 | 0.019 | 0.017 |

The results confirm that thin glasses having the shown compositions having an improved integrated property of bendability and chemical toughenability (DoL in a low level while the CS goes higher, low E-modulus). Further the glasses have improved radiation resistance (solarization stability, UV blocking) and acid resistance.

What is claimed is:

1. A chemically toughenable or toughened glass having, before chemical toughening, a thickness of at most 500 μm, and comprising a composition in wt. % on oxide basis:

| | |
|---|---|
| SiO2 | 52-66 |
| B2O3 | 0-8 |
| Al2O3 | 15-25 |
| Na2O | 0-20 |
| MgO | 0-6 |
| ZrO2 | 0-2.5 |
| SnO2 | 0.01-1 |
| R2O | 4-30 |
| CeO2 + SnO2 | 0.01-1.5 |
| TiO2 + CeO2 | 0-2.5 |
| Al2O3 + Na2O + MgO + | 16-45 |
| ZrO2 | |

wherein, after chemical toughening, the glass has a BACT (bendability and chemical toughenability) calculated as BACT=(CS*DoL)/(t*E) which is greater than 0.00050 and/or a NS (normalized stiffness) calculated as NS=CS/E which is greater than 0.0085,
wherein CS is a compressive stress in MPa measured at one side of the glass after chemical toughening, DoL is a total depth of all ion-exchanged layers in μm on one side of the glass after chemical toughening, t is a thickness of the glass in μm after chemical toughening, and E is a E-modulus in MPa after chemical toughening.

2. The glass according to claim 1, further comprising in wt. % on oxide basis:

| | |
|---|---|
| P2O5 | 0-5 |
| Li2O | 0-6 |
| K2O | 0-5 |
| ZnO | 0-4 |
| CaO | 0-5 |
| SrO | 0-1 |
| TiO2 | 0-2 |
| CeO2 | 0-0.5 |
| F | 0-1. |

3. The glass according to claim 1, wherein the BACT is greater than or equal to 0.00070.

4. The glass according to claim 1, wherein the NS is greater than 0.010.

5. The glass according to claim 1, further comprising a sum (ZrO2+Al2O3+TiO2) in a range of 15 to 30 wt. % and/or has Na2O/(Na2O+K2O)>0.4 to 1.

6. The glass according to claim 1, wherein the glass thickness before chemical toughening is from >1 μm to ≤500 μm.

7. The glass according to claim 1, wherein the E-modulus is from 60 to 120 GPa.

8. The glass according to claim 1, wherein the compressive stress (CS) after chemical toughening is from ≥700 MPa to <2000 MPa.

9. The glass according to claim 1, wherein the DoL after chemical toughening is from greater than 1 μm to less than 0.5*t.

10. The glass according to claim 1, further comprising an acid resistance in mg/dm2 of less than 150.

11. The glass according to claim 1, further comprising a difference of transmission, at a wavelength of 350 nm, measured before and after UV exposure that is less than 45% referred to a glass thickness of ≤500 μm and/or having a difference of transmission, at a wavelength of 400 nm, measured before and after UV exposure that is less than 10% referred to a glass thickness of ≤500 μm.

12. The glass according to claim 1, further comprising a transmission at a wavelength of 300 nm that is less than 10% referred to a glass thickness of ≤500 μm.

13. The glass according to claim 1, further comprising a Haze value after acid treatment at 6 mol/l HCl for 6 h boiling of less than 90% and/or a Haze value after climate treatment at a temperature 25 to 85° C., humidity of ≥50% to ≤90%, storage for 30 days to 365 days of less than 5%.

14. The glass according to claim 1, further comprising at least one surface with a roughness Ra of less than 5 nm.

15. The glass according to claim 1, further comprising a temperature difference ΔT between a working temperature T4 and a maximum crystallization temperature TOEG that is higher than 50 K.

16. The glass according to claim 1, further comprising a coefficient of thermal expansion (CTE) of from greater than 5 to less than 12 ppm/K in a temperature range of from 20° C. to 300° C.

17. The glass according to claim 1, wherein the glass is configured for a use selected from a group consisting of an industrial display, a consumer display, an OLED, a photovoltaic cover, an organic complementary metal oxide semiconductor (CMOS), a finger print sensor, a protective cover film, a camera module, a foldable display, a flexible display, and an electronic device.

18. A method for producing a glass, comprising the steps of:
providing a composition in wt. % on oxide basis:

| | |
|---|---|
| SiO2 | 52-66 |
| B2O3 | 0-8 |
| Al2O3 | 15-25 |
| Na2O | 0-20 |
| MgO | 0-6 |
| ZrO2 | 0-2.5 |
| SnO2 | 0.01-1 |
| R2O | 4-30 |
| CeO2 + SnO2 | 0.01-1.5 |
| TiO2 + CeO2 | 0-2.5 |
| Al2O3 + Na2O + MgO + | 16-45 |
| ZrO2 | |

melting the composition;
producing the glass in a flat glass process into a flat glass having a thickness of at most 500 μm; and
chemically toughening the flat glass, wherein, after the step of chemical toughening the flat glass has a BACT (bendability and chemical toughenability) calculated as BACT=(CS*DoL)/(t*E) which is greater than 0.00050 and/or a NS (normalized stiffness) calculated as NS=CS/E which is greater than 0.0085,
wherein CS is a compressive stress in MPa measured at one side of the flat glass after chemical toughening, DoL is a total depth of all ion-exchanged layers in μm on one side of the flat glass after chemical toughening, t is a thickness of the flat glass in μm after chemical toughening, and E is a E-modulus in MPa after chemical toughening.

19. The method according to claim 18, wherein the flat glass process is a drawing process.

20. The method according to claim 18, further comprising, during the flat glass process, cooling the flat glass at an average cooling rate in a temperature region corresponding to a glass viscosity of 1010 dPas to 1015 dPas is from greater than 5° C./s to less than 200° C./s.

21. The method according to claim 18, further comprising, during the flat glass process, annealing the flat glass at an annealing rate of less than 50° C./min in a temperature region between an annealing point and room temperature.

22. The method according to claim 18, wherein the step of chemically toughening comprises at least one toughening step comprising toughening in a toughening agent comprising KNO3.

23. The method according to claim 18, wherein the step of chemically toughening comprises at least one toughening step comprising toughening in a toughening agent comprising CsNO3.

24. The method according to claim 18, wherein the step of chemically toughening is done at a temperature of from greater than 320° C. to less than 500° C.

25. The method according to claim 18, wherein the step of chemically toughening comprises a total duration of between 0.01 and 20 hours.
